(19) United States
(12) Patent Application Publication
(10) Pub. No.: US 2011/0262065 A1
(43) Pub. Date: Oct. 27, 2011

(54) Bearing Assembly With T-Shaped Bearing Member

(76) Inventors: Dharani U. Babu, Hadapsar (IN); Scott Alan Tebbe, Cedar Falls, IA (US)

(21) Appl. No.: 12/767,485

(22) Filed: Apr. 26, 2010

(51) Int. Cl. F16C 32/00

(52) U.S. Cl. 384/416

(57) ABSTRACT

A bearing assembly movably supports a component on a shaft. The bearing assembly includes a pair of annular bands spaced apart axially and projecting radially inwardly from the component. The bands form an annular slot therebetween. An annular bearing member is mounted on the shaft. The bearing member has a larger diameter central flange and a pair of smaller diameter rings projecting axially for opposite sided of the central flange. The central flange is received by the slot, and each ring is positioned between the shaft and a respective one of the bands. The bearing member has a T-shaped cross-sectional shape.

### FIELD OF THE INVENTION

The present invention relates to a shaft bearing assembly.

### BACKGROUND OF THE INVENTION

In a variable speed belt drive a belt pulley sheave is axially slidable on a shaft.

Bearings are required to prevent wear between the relatively movable parts. There are many low friction bearings/bushings commercially available to prevent wear between two moving parts. The available bearings require either a press fit to one part or a flange at either end to hold the bearing in position. Press fit bearings require tight tolerance control in machining and must have clearance holes larger than the bearing outer diameter to position the bearing in the press fit bore. Bearings with flanges at each end require extra axial length in the design and the flange part provides limited support because it is not backed up.

### SUMMARY OF THE INVENTION

Accordingly, an object of this invention is to provide a bearing assembly which does not require a press fit.

A further object of the invention is to provide such a bearing assembly which does not require tight tolerance control in machining.

These and other objects are achieved by the present invention, wherein a bearing assembly movably supports a component on a shaft. The bearing assembly includes a pair of annular bands which are spaced apart axially and which project radially inwardly from the component. The bands form an annular slot therebetween. An annular bearing member is mounted on the shaft. The bearing member has a larger diameter central flange and a pair of smaller diameter rings projecting axially from opposite sides of the central flange. The central flange is received by the slot, and each ring is positioned between the shaft and a respective one of the bands. The bearing member has a T-shaped cross-sectional shape.

### BRIEF DESCRIPTION OF THE DRAWINGS

FIG. 1 is a sectional perspective view of a bearing assembly embodying the invention; and

FIG. 2 is a perspective view of the bearing member of FIG. 1.

### DESCRIPTION OF THE PREFERRED EMBODIMENT

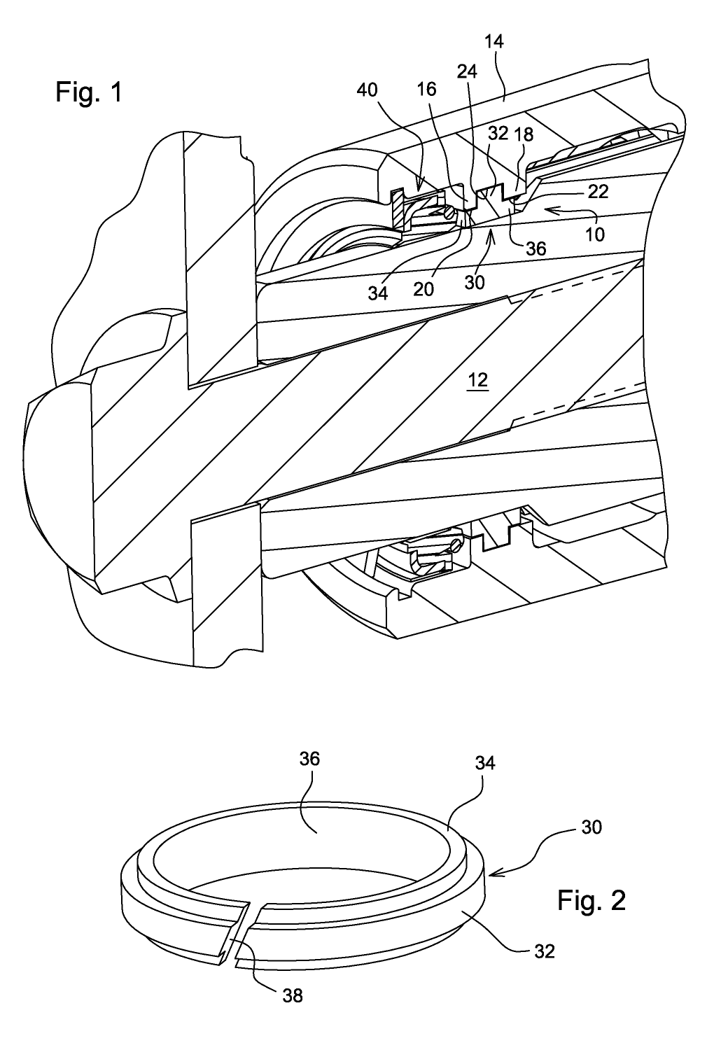

Referring to FIG. 1, a bearing assembly 10 movably supports a component 14 for axial sliding on a shaft 12. The component may be a movable sheave of a variable belt drive (not shown). The component 14 forms a pair of annular band members 16 and 18 which are spaced apart axially and which project radially inwardly from the component 14. Each band member 16 and 18 has an inner surface 20, 22 which is spaced apart radially from the shaft 12. The band members 16, 18 form an annular slot 24 therebetween with a rectangular cross-sectional shape.

An annular cylindrical bearing member 30 is mounted on the shaft 12. The bearing member 30 has a larger diameter central flange 32 and a pair of smaller diameter rings 34 and 36 projecting axially from opposite sides of the radially inner portion of the central flange 32. The central flange 32 is received by the annular slot 24. Each ring 34, 36 is positioned between the shaft 12 and the inner surface 20, 22 of a respective one of the band members 16, 18. The bearing member 30 has a T-shaped cross-sectional shape in a plane which contains an axis of the shaft 12.

The base material of the bearing member 30 can be polymeric, fibrous, or metallic. The bearing material may have additives to modify the properties of the bearing. The bearing member 30 should have sufficient flexibility and spring rate that it can be wrapped over itself or folded in on itself during installation and returned to its circular form in the assembly without damage. The bearing member 30 may be split, such as at 38, from the inner diameter to the outer diameter so it can be wrapped on itself to ease installation. The split may be any width or angle necessary to install the bearing member 30.

With this bearing assembly 10, the machining tolerances can be larger because a press fit is not required to keep the bearing member 30 in place. The T-shape of the bearing member 30 minimizes the working axial distance used in the assembly 10 and allows for a more axially compact design. The flexible nature of the bearing material allows it to be manipulated to fit though a smaller hole than a press fit bearing would fit through during assembly. Backup rings and snap rings can be eliminated from the assembly.

Preferably, a conventional seal assembly 40 is mounted adjacent to the bearing assembly 10 between the shaft 12 and the component 14.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A bearing assembly for movably supporting a component on a shaft, the assembly comprising:
an annular slot formed in a surface of the component which faces towards the shaft; and
an annular bearing member mounted between the component and the shaft, the bearing member having a larger diameter central flange and a pair of smaller diameter annular rings projecting axially from opposite sides of a radially inner portion of the central flange, the central flange being received by the annular slot, and the rings being positioned between the component and the shaft.

2. The bearing assembly of claim 1, wherein:
the bearing member has a T-shaped cross-sectional shape in a plane which contains an axis of the shaft.

3. The bearing assembly of claim 1, wherein:
the bearing member has a split extending therethrough.

4. The bearing assembly of claim 1, wherein:
the component forms a pair of annular band members spaced apart axially from each other on opposite sides of the slot, the band members projecting radially inwardly to an inner surface spaced apart from the shaft; and
each ring being positioned between the shaft and the inner surface of a respective one of the band members.

5. A bearing assembly for movably supporting a component on a shaft, the assembly comprising:
a pair of annular band members formed by the component, the band members being spaced apart axially from each other and projecting radially inwardly, each band member having an inner surface spaced apart from the shaft, the band members forming an annular slot therebetween; and
an annular bearing member mounted on the shaft, the bearing member having a larger diameter central flange and a pair of smaller diameter rings projecting axially from opposite sides of the central flange, the central flange being received by the annular slot, and each ring being positioned between the shaft and the inner surface of a respective one of the band members.
